(19) United States
(12) Patent Application Publication
(10) Pub. No.: US 2002/0161452 A1
(43) Pub. Date: Oct. 31, 2002

(54) Hierarchical collective memory architecture for multiple processors and method therefor

(76) Inventor: Michael G. Peltier, Oro Valley, AZ (US)

Correspondence Address: WEISS & MOY PC, 4204 NORTH BROWN AVENUE, SCOTTSDALE, AZ, 85251, US

(21) Appl. No.: 10/127,071

(22) Filed: Apr. 19, 2002

Related U.S. Application Data
(60) Provisional application No. 60/286,839, filed on Apr. 25, 2001.

(51) Int. Cl. G05B 19/18

(52) U.S. Cl. 700/2; 700/3; 700/5

(57) ABSTRACT

A method and means which allow multiple processors to operate efficiently as a single system while providing some autonomy for individual tasks is disclosed. The current invention further provides an architecture that is virtually infinitely scalable without reaching a limitation in throughput, which is normally associated with multiple processor architectures.

### RELATED APPLICATIONS

This patent application is claiming the benefit of the U.S. Provisional Application having an application No. 60/286,839 filed Apr. 25, 2001, in the name of Michael G. Peltier, and entitled “HIERARCHICAL COLLECTIVE MEMORY ARCHITECTURE FOR MULTIPLE PROCESSORS”.

### BACKGROUND OF THE INVENTION

1. Field of the Invention

This Invention relates to multiple processor architectures for digital computers. Specifically, to provide a method and means for allowing an arbitrarily large array of multiple processors to map each processor's memory space to one or more collective groups of memory from an arbitrarily large shared memory array, thereby allowing subgroups of processors to share a collective task as an autonomous group, to provide a tree-like hierarchal memory structure for collective tasks, and to allow use of a shared memory array that is larger than the address space of any individual processor.

2. Description of the Prior Art

As the use of Information Technologies (IT) has increased over the past years, so too has the need for more throughput from digital computers. Most modern solutions for demanding IT applications involve using Multiple Processors (MP), which generally communicate through shared memory, or multiple computers, which generally communicate over a network. These solutions increase throughput by parallel processing, in which one or more tasks are processed concurrently by a plurality of processing devices. While these solutions were satisfactory at one time, demands on IT services have revealed a number of bottlenecks regarding these solutions.

In the case where multiple processors are employed, a limitation was quickly realized regarding the bandwidth of the shared memory bus. That is, as the number of processors increase the demand on the shared memory bus also increase. This increase in demand results in longer latency times causing processors to wait for access to shared memory. Once the bandwidth on the shared memory bus is saturated, adding more processors only increases each processor's average wait time and no additional throughput is realized regardless of the number of processors added to the system.

Several solutions to the problem of shared memory bus saturations described above have been presented. These solutions include caching memory locally, as taught by Sood et al., U.S. Pat. No. 5,146,607, and providing multiple busses or data paths for shared memory, as taught by Shelor, U.S. Pat. No. 4,807,148. While these solutions allow more processors to effectively use shared memory, they still do not allow an arbitrarily large number of processors to share the same memory. In addition, as a result of being able to add more processors to the shared memory, a new limitation has recently been realized; with many processors sharing the same memory space the logical allocation of memory quickly consumes the entire memory address space available to the processors. Because each shared task requires some space in the shared memory map, the maximum possible size of the memory (which is determined by the number of bits on the processor's address bus) places a limit on the number of tasks that can be executed concurrently.

In the case where parallel processing is accomplished over a network, each computer in the network has private memory, which is not shared. This eliminates the problem of congestion on a shared memory bus. Individual computers on a network only need to allocate memory for the tasks that are assigned to that node, unlike a shared memory which must provide memory space for each task system-wide regardless of which processors are performing that task. As such, the number of tasks per node are reduced, thereby reducing the likelihood of expanding the available address space. In addition, a network will allow use of an arbitrarily large number of computers for parallel processing.

The disadvantage of network-based parallel processing is that information common to several computers must be physically transferred from one computer to the next, which reduces throughput and causes data coherency problems. Also, data transferred between computers on a network must typically be converted to and from a portable data format, which also reduces throughput. In practice, the benefits of using of individual computers on a network for parallel processing is generally limited to specific applications, where a common data set can be logically broken into discrete autonomous tasks and the amount of data required to be transferred is small with respect to the time required to process said data.

Given the limitations of network-based parallel processing, most solutions have concentrated on improving the throughput of multiple processor architecture for multiple processing. While improvements have been made, there has yet to be a solution that allows an arbitrary number of processors to be added without reaching a limit on throughput, as the following discussion of prior will reveal.

Therefore, a need existed to provide a method and means to overcome shared memory congestion and increase throughput. The system and method must allow an arbitrary number of processors to be added without reaching a limit on throughput.

### SUMMARY OF THE INVENTION

In accordance with one embodiment of the present invention, it is an object of the present invention to provide a method and means to overcome shared memory congestion and increase throughput.

It is another object of the present invention to provide a method and means to overcome shared memory congestion and increase throughput system which allows an arbitrary number of processors to be added without reaching a limit on throughput.

### BRIEF DESCRIPTION OF THE EMBODIMENTS

In accordance with one embodiment of the present invention a data processing system is disclosed. The data processing system has a plurality of processors. A local memory bus is coupled to the processor. Local memory is coupled to at least one of the plurality of processors via the local memory bus. A shared memory is coupled to the plurality of processors. A common memory bus is coupled to the shared memory. At least one address translator is coupled to the plurality of processors and the shared memory for converting local bus addresses presented on the local memory bus to a larger address range which is applied to the common memory bus and the shared memory.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified functional block diagram of a prior art multi-processor computer system.

FIG. 2 is a simplified functional block diagram of a prior art method for memory mapping for the multi-processor system depicted in FIG. 1.

FIG. 3 is a simplified functional block diagram of another prior art multi-processor computer system.

FIG. 4 is a simplified functional block diagram of a prior art method for memory mapping for the multi-processor system depicted in FIG. 3.

FIG. 5 is a simplified functional block diagram of a multi-processor computer system of the present invention.

FIG. 6 is a simplified functional block diagram of an address translator used in the multi-processor computer system of FIG. 5.

FIG. 7 is a simplified functional block diagram of a method for memory mapping for the multi-processor system depicted in FIG. 5.

FIG. 8 is a side-by-side comparison of memory maps for the hypothetical example depicted in FIG. 7.

FIG. 9 shows the hierarchal structure of the memory maps depicted in FIG. 8.

FIG. 10 shows the hierarchal structure of the prior art memory maps.

FIG. 11 shows the hierarchal structure of the memory maps for another hypothetical.

### DETAILED DESCRIPTION OF THE PREFERRED EMBODIMENT

Referring now to FIG. 1, a typical architecture for a multi-processor system is shown. Processors 101, 102, 103, and 104 are connected to shared memory 105 by common memory bus 200. Note that any number of processors greater than one can be used. The present embodiment illustrates four processors. This architecture has several advantages over a single processor design in that tasks can be performed in parallel by the four processors (101 through 104) concurrently, thereby increasing throughput. In addition, all four processors share the same memory, which means common data does not need to be transferred from one processor's memory to another; each processor has immediate access to the same data without the need for a memory-to-memory or computer-to-computer transfer.

This architecture has two disadvantages. One disadvantage is that as more processors are added, the congestion on common memory bus 200 increases. When the common memory bus 200 reaches the saturation point, the addition of more processors will not realize an increase in throughput because each processor will spend more time waiting for access to common memory bus 200.

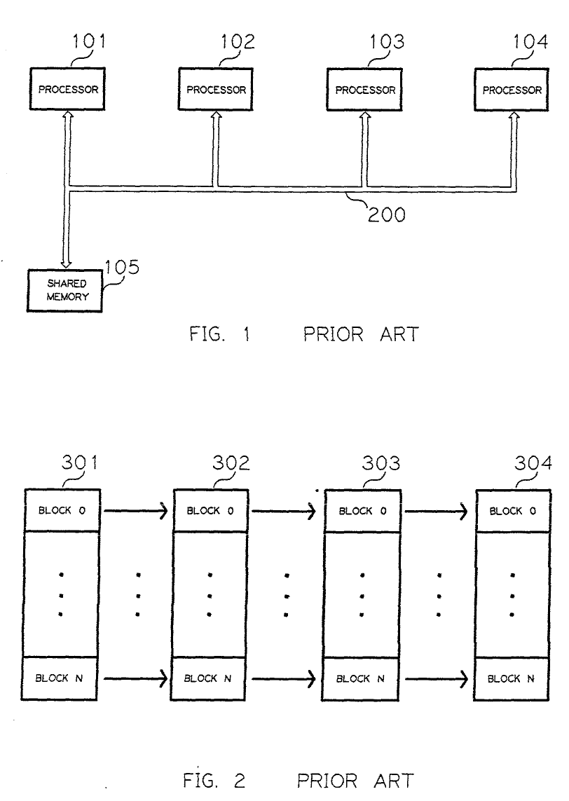

Another disadvantage with this architecture is the fact that each processor must compete for use of common memory bus 200 even when accessing data that does not need to be shared between processors. For an explanation, referring now to FIG. 2. Memory maps 301, 302, 303, and 304 represent the memory mapping for processors 101, 102, 103, and 104 respectively. Note that block 0 through block N on memory map 301 is identical to memory maps 302, 303, and 304. This is because the four memory maps all reflect the same physical memory. If a piece of information is changed in memory map 301, the same change immediately appears in memory maps 302, 303, and 304. While this is a distinct advantage for data that is unique to each processor, it is also a disadvantage for data that is unique to each processor. For example, the stack space for processor 101, which is of no interest to the other three processors (102, 103, and 104), appears on all four memory maps (301, 302, 303, and 304). As such, any data that is unique to each processor must be allocated at different addresses for each processor; the result is a waste of usable address space. Furthermore, each processor must compete for space on common memory bus 200 in order to access data that does not pertain to the other processors.

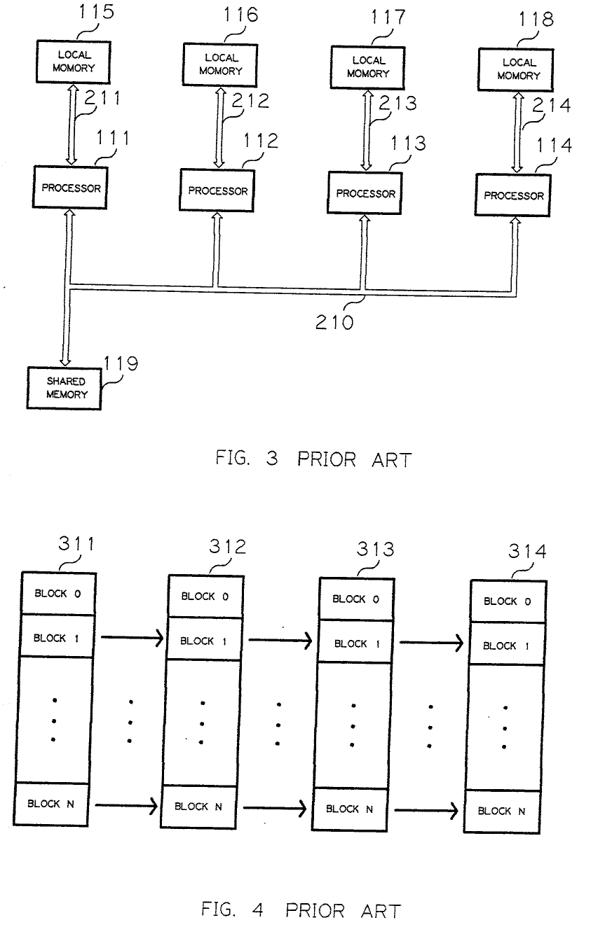

A more efficient solution is illustrated in FIG. 3. A plurality of processors (111, 112, 113, and 114) are connected by common memory bus 210 to shared memory 119. In addition, each processor (111, 112, 113, and 114) is connected by a local bus (211, 212, 213, and 214 respectively) to individual local memories (115, 116, 117, and 118 respectively).

The resulting memory maps for processors 111, 112, 113, and 114 are illustrated in FIG. 4 as memory maps 311, 312, 313, and 314 respectively. Notice that Block 0 on each of the memory maps (311, 312, 313, and 314) is unique to each of the respective processors (111, 112, 113, and 114) because they each represent different physical memories (115, 116, 117, and 118 respectively) Blocks 1 through N are identical for each of the four processors (111, 112, 113, and 114) because they represent the same physical memory 119.

If data that does not need to be shared is allocated in Block 0 on each of the memory maps (311, 312, 313, and 314) while shared data is allocated in Blocks 1 through N, then memory access operations for data that is not shared takes place on separate logical busses (211, 212, 213, and 214 respectively). This reduces the demand on shared memory bus 210, thus increasing throughput and allowing more processors to be added to the system before the saturation point of shared memory bus 210 is reached.

While the architecture in FIG. 3 is an improvement over that of FIG. 1, there are still several shortcomings, which place a limit on throughput. One limit is still saturation of the shared memory bus 210. For example, if processors 111 and 112 are performing task A and processors 113 and 114 are performing task B, then data for both tasks A and B must be stored in the shared section of memory maps 311, 312, 313, and 314. This means that processors 111 and 112 not only have to compete with each other for access to shared bus 210 while performing task A, but they must also compete with processors 113 and 114 as the latter performs task b, and vice-versa.

Furthermore, the shared section of memory maps 311 and 312 only require memory allocations for task A being performed by processors 111 and 112. Likewise, the shared section of memory maps 313 and 314 only require memory allocations for task B being performed by processors 113 and 114. However, since memory maps 311, 312, 313, and 314 all represent the same physical memory, space for both tasks A and B must be allocated in the shared memory space of all four memory maps, resulting in an inefficient use of memory address space.

As can be seen above, adding additional processors to this architecture in an effort to increase throughput will eventually saturate shared memory bus 210 and no additional throughput will be realized. Also, as more tasks are added to the system, the available address space on each of the memory maps 311, 312, 313, and 314 will become congested placing a limit on the number of tasks that can be executed concurrently.

Some architectures similar to that of FIG. 3 employ multiple data paths for shared memory bus 210 in order to reduce congestion on any single data path. While this solution will provide some relief for bus saturation, it will not relieve congestion of the available memory address space. That is, a limitation is still reached in terms of the number of tasks that can be executed concurrently.

The current invention provides a method and means to allow an arbitrary large number of processors and/or computers to share an arbitrarily large memory space without reaching a point where additional processing devices no-longer produce additional throughput and no limitation is placed on the number of concurrently running tasks.

While most solutions to throughput congestions are approached from strictly a hardware standpoint (i.e., improving throughput at the hardware level only), the current invention approaches the problem from the logical unit of work performed by each processing unit, the “task”. That is, it is not enough to simply seek a solution that moves data to or from memory faster. In order to present a viable solution the reason why data is being moved to and from memory must also be considered. In particular, IT equipment requires high throughput to accomplish tasks; movement of data to and from memory is subordinate hardware operation that supports the task.

Typically, each task either consists of sub tasks (e.g., child processes, support routines, lower software abstraction layers, etc.), and might also in themselves be a sub task of a higher process (e.g., a parent process, higher software abstraction layer, etc.). These tasks are often implemented in software in the form of a tree-like hierarchal structure where a root process or task responsible for overall system operation spawns child processes or tasks. These child processes, in turn, might spawn additional child processes or tasks, and so on. Therefore, in order to reduce shared memory congestion, the physical memory architecture must also reflect the tree-like hierarchal structure of the tasks and task data stored in it.

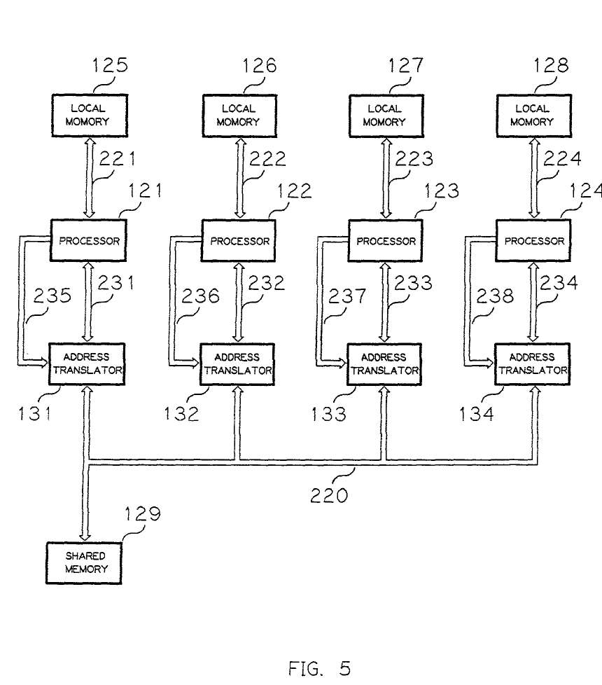

Referring to FIG. 5, processor 121 is connected by a private local memory bus 221 to a local memory 125, which forms a private memory subsystem for storage of information unique to processor 121. In addition, processor 121 is connected by a private memory subsystem to address translator 131. A control bus 235 allows configuration information to be applied from processor 121 to address translator 131. A similar arrangement exists for processors 122, 123, and 124, private memory busses 222, 223, 224, 232, 233, and 234, local memories 126, 127, and 128, address translators 132, 133, and 134, and control busses 236, 237, and 238. Each of the address translators 131, 132, 133, and 134 are connected by common memory bus 220 to shared memory 129.

The address translators 131, 132, 133, and 134 convert the local bus address presented on local busses 231, 232, 233, and 234 to a larger address range which is applied to common memory bus 220 and shared memory 129. The maximum address space on common memory bus 220 and shared memory 129 can be arbitrarily large, in much the same fashion that either addresses are arbitrarily large, thereby allowing shared memory 129 to be expanded to an arbitrarily large size. Note that although the example in FIG. 5 illustrates four processors, any number of processors may be employed.

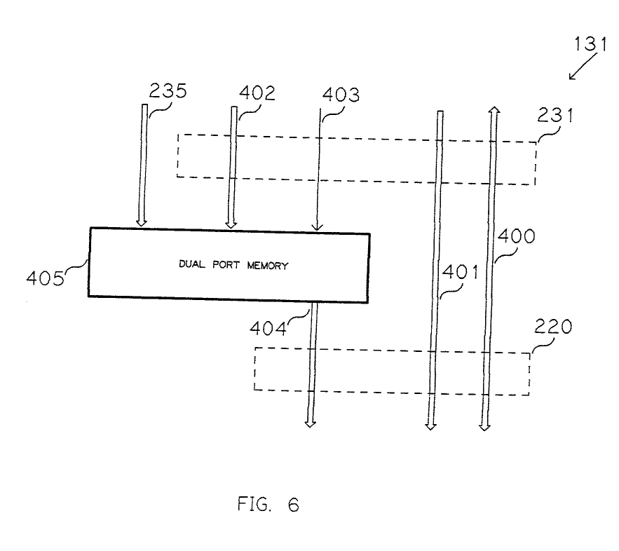

Address translator 131 is shown in more detail in FIG. 6. Information presented on the control bus 235 is stored in a dual port memory 405 via the write port of the memory. Local memory bus 231 is shown in more detail as data and control signals 400, lower address signals 401, block address signals 402, and enable signal 403. The common memory bus 220 is also shown in more detail as data and control signals 400, lower address signals 401, and block address signals 404.

Data and control signals 400, as well as the lower address signals 401 are passed from the local memory bus 231 to the common memory bus 220 unaltered. The block address signals 402 (i.e., upper address information) is used to address or index a data word in the dual port memory 405 when enabled signal 403 becomes active. The output word from the dual port memory 404 is applied to common memory bus 220 as the translated block address.

As an example, if the block address 402 from the local memory bus 231 consists of four bits, and dual port memory 404 is a 32-bit by 16 memory, then the block address signals 404 applied to the shared memory bus 220 will be 32-bits wide. Dual port memory 404 functions as an address look-up register that converts the 4-bit block address signals 402 from the local memory bus 231 to 32-bit addresses presented to the common memory bus 220. That is, each of the possible 16 block addresses presented by block address signals 402 will be converted to one of 4,294,967,296 possible block addresses at the common memory bus 220. The specific value of each conversion is stored into the dual port memory 404 by control bus 235 during configuration or re-configuration phase.

The result is the limited address range of the local memory bus 231 is re-mapped to a much larger memory address space on common memory bus 200. This technique also allows shared memory to be re-configured in a shared hierarchal structure that is coherent with a hierarchy of tasks performed by the system as a whole.

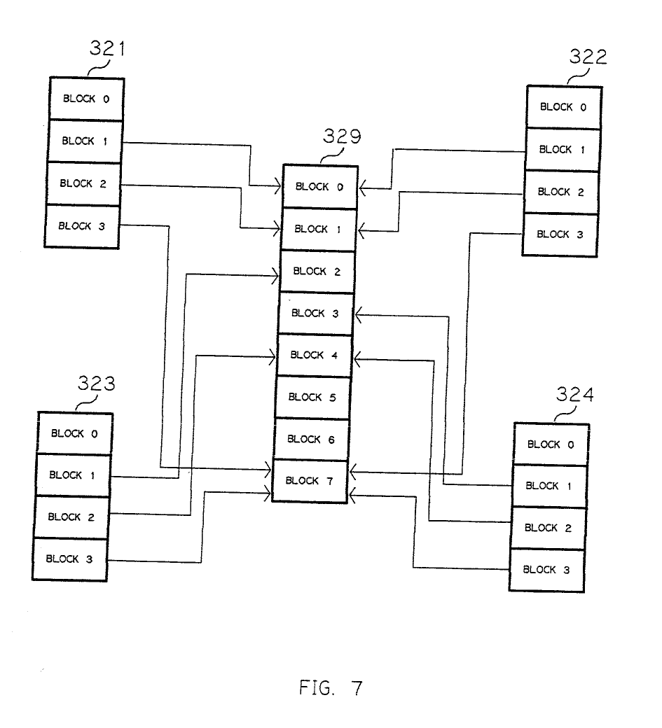

Consider the hypothetical translated address mapping shown in FIG. 7. Memory maps 321, 322, 323, and 324 are memory maps for processors 121, 122, 123, and 124 respectively, while memory map 329 is the memory map for the shared memory 129. Block 0 of memory maps 321, 322, 323, and 324 represent the local memory 125, 126, 127, and 128 respectively for each of the processors 121, 122, 123, and 124 respectively, and is unique for each memory map. The remaining blocks (Block 1, 2, and 3) are re-mapped to a spaced in shared memory.

Notice that memory map 321 appears to be a continuous monolithic address space to the processor for which it applies. However, the physical storage of these blocks in the shared memory map 329 is not. Specifically, blocks 1 and 2 are translated or re-mapped to blocks 0 and 1 respectively in shared memory 329, and block 3 is re-mapped to block 7 in shared memory 329. Memory map 322 contains the same translations as memory map 329 as follows: block 1 is mapped to block 2, block 2 is mapped to block 4, and block 3 is mapped to block 7. Memory map 324 is re-mapped to the shared memory map 329 as follows: block 1 is mapped to block 3, block 2 is mapped to block 4, and block 3 is mapped to block 7. Notice that some blocks in shared memory map 329 are shared between two or more of the processor memory maps 321, 322, 323, and 324, while others are not.

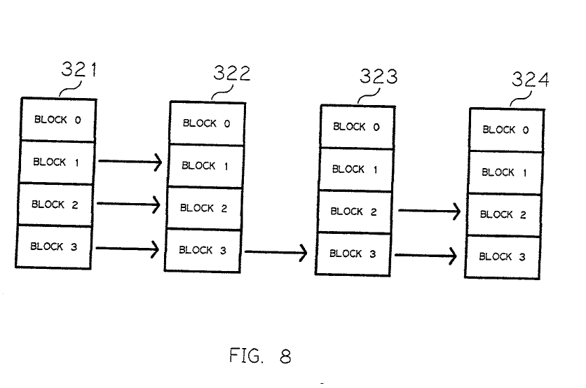

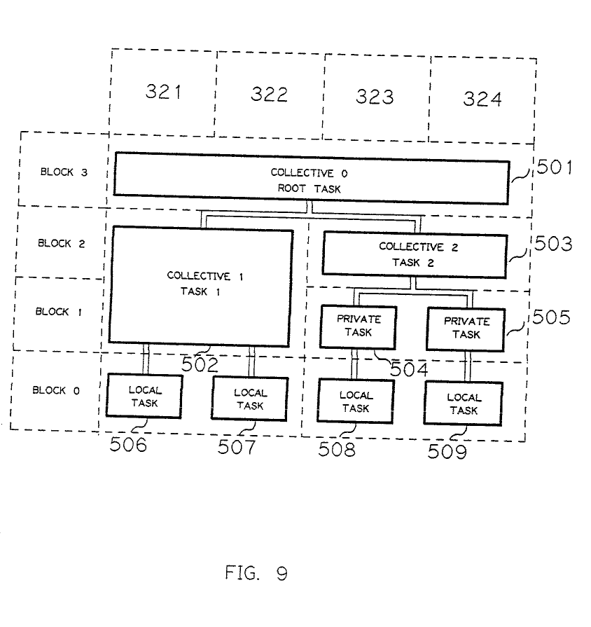

A side-by-side comparison or memory maps 321, 322, 323, and 324 is illustrated in FIG. 8. Block 0 on all four memory maps is mapped to local memory for each of the respective processors and is unique for each of the four memory maps. Block 1 on memory map 323 is mapped to shared memory (block 2 on shared memory map 329), but since this block in shared memory is not used by the other three memory maps (321, 322, or 324) it is logically treated as private memory. That is, any changes made to block 1 of memory map 323 will not be reflected in the other three memory maps. The same holds true for block 1 on memory map 324, which is mapped to Block 3 on shared memory map 329.

This is not the case, however, for block 1 on memory maps 321 and 322, which are both mapped to block 0 on shared memory map 329. That is any change that is made to data in block 1 on memory map 321 will instantly appear in block 1 on memory map 322 because both blocks are the same physical memory. The same holds true for block 2 of memory maps 321 and 322, which are both mapped to block 1 of shared memory map 329. A similar relationship is present between block 2 of memory maps 323 and 324, which are both mapped to block 4 of shared memory map 329. That is, any change in block 2 of memory map 323 will instantly appear in block 2 of memory map 324. Finally, block 3 on all three memory maps are mapped to block 7 on shared memory map 329. That is, any change made to block three on any of the four memory maps will instantly appear on the other three memory maps because they all represent the same physical memory.

This mapping technique allows shared memory to be selectively configured; the system can control which blocks in shared memory will be shared by which processors. As far as the example in FIG. 8, blocks 1 and 2 on memory maps 321 and 322 collectively form a shared memory group, blocks 2 on memory maps 323 and 324 collectively form another shared memory group, and block 3 on all four memory maps collectively form a third shared memory group. Each of these discrete memory groups will hereafter be referred to as a “collective group”, or more simply, a “collective”.

Under normal operating conditions, each collective group will be allocated on a task-by-task basis. Because tasks tend to be logically arranged in a tree-like hierarchal structure, the collective groups will also tend to be arranged in a tree-like hierarchal structure. The example in FIG. 8 reflects a tree-like hierarchal structure, though it may not be outwardly evident when presented in this format.

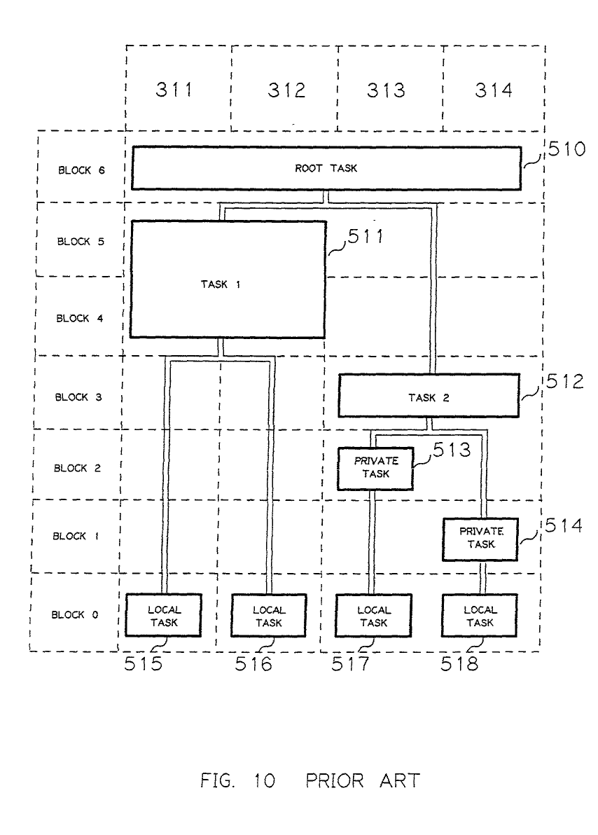

The hierarchal structure of the memory maps in FIG. 8 becomes more apparent when this information is re-arranged as shown in FIG. 9, which illustrates a multiprocessor mapping chart. The left side header of the chart shows the block number for each block of memory, while the top header of the chart shows the memory map identifiers 321, 322, 323, and 324 corresponding to the memory maps of processors 121, 122, 123, and 124 respectively. The body of the chart shows which task is stored or allocated to each collective or private memory groups.

As noted in FIGS. 7 and 8, block 3 of memory maps 321, 322, 323, and 324 are all mapped to the same physical block of memory; this is shown as collective 0 (501) on FIG. 9, which is allocated to the root task. The root task is typically responsible for top-level management of tasks system-wide and for allocation and de-allocation of resources. In this example, the root task has spawned two child tasks: task 1, which is allocated as collective 1 (502), and task 2, which is allocated as collective 2 (503). Assume for sake of example, that processors operating on task 2 require additional private memory, which is shown as private tasks 504 and 505. Because each of these blocks are mapped to different locations in the shared memory map 329, they become private memory regardless of the fact that they are physically located in the shared memory 129. Local tasks 506, 507, 508, and 509 are mapped to local memories 125, 126, 127, and 128 respectively (FIG. 5), and are used for storage of processor-specific tasks (i.e., not shared).

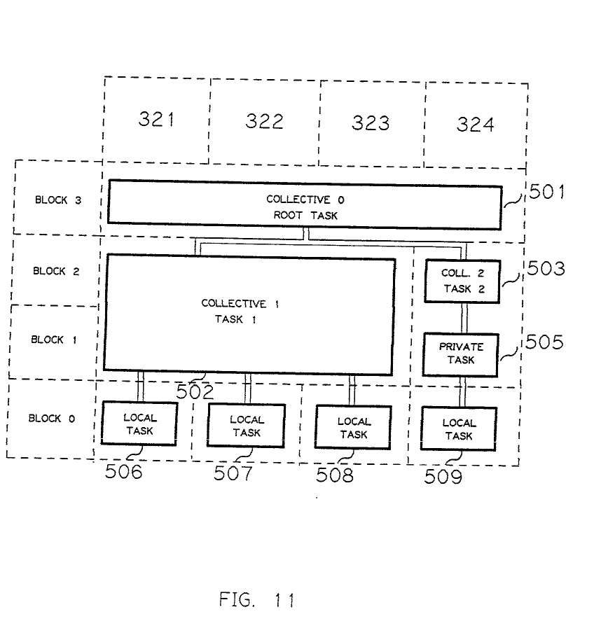

Note that if the same task structure were allocated on an architecture similar to the prior art shown in FIGS. 3 and 4, the resulting chart would resemble that of FIG. 10, where allocated regions 510, 511, 512, 513, 514, 515, 516, 517, and 518 correspond to 501, 502, 503, 504, 505, 506, 507, 508, and 509 respectively. Note that the current invention (FIG. 9) only requires 4 blocks of memory as compared to the 7 blocks of memory requires by prior art (FIG. 10); the current invention makes more efficient use of each processors's address space.

As can be seen in FIG. 10 (prior art), if a large number of processors were added to the system in an effort to increase throughput, there would still be a limitation of to the number of tasks that could be executed concurrently. That is, no additional tasks could be added to the system once the total number of blocks available on a single processor's address space were allocated to tasks. This problem is eliminated in the current invention (FIG. 9) because memory space in one collective group on another collective with the same block address. Therefore, an arbitrarily large number of tasks can be executed using the current invention providing enough processors were added to the system.

The current invention also allows for expedient re-allocation of resources. Consider the example in FIG. 9. If the root task detects that the load on task 2 501 has increased and the load on task 2 503 has decreased, then the root process can order processor 123 (see FIG. 5) to re-configure address translator 133 to use the same memory mapping as either processor 121 or 122. The resulting composite memory map would then resemble that shown in FIG. 11. As can be seen in FIG. 11, task 1 allocated to collective 1 (502) is now supported by three processors while task 2 allocated to collective 2 (503) is now only supported by one processor. This technique allows processing resources to be dynamically re-allocated to optimize throughput for changing load conditions.

The throughput of the current invention will also be improved by employing multiple data paths to reduce congestion on common memory bus 220 (see FIG. 5). Under optimal conditions, each collective group should have a separate data path in order to eliminate conditions where a group of processors assigned to a task are competing for shared memory access with processors assigned to a completely different task. More specifically, separate data paths to individual blocks of shared memory will ensure that processes assigned to a collective will not compete with processors assigned to unrelated collectives for access to shared memory. The result is a system that can be expanded by adding an arbitrarily large number of processors and an arbitrarily large shared memory without reaching a limit on throughput. Furthermore, the system is also capable of accepting an arbitrarily large number of tasks with out expending the processor's available address space. It should also be noted that shared memory 129 need not be a single continuous physical memory, but can be physically distributed amongst the plurality of processors or plurality of address translators, thereby allowing the system as a whole to be constructed on a modular basis and allowing the system to be expanded as the need or system demands dictate.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A data processing system comprising, in combination:
a plurality of processors;
a local memory bus;
local memory coupled to at least one of the plurality of processors via the local memory bus;
shared memory coupled to the plurality of processors;
a common memory bus coupled to the shared memory; and
at least one address translator coupled to the plurality of processors and the shared memory for converting local bus addresses presented on the local memory bus to a larger address range which is applied to the common memory bus and the shared memory.

2. A data processing system in accordance with claim 1 further comprising at least one local memory coupled to each of the plurality of processors via the local memory bus.

3. A data processing system in accordance with claim 1 further comprising at least one local memory bus coupled to each of the plurality of processors.

4. A data processing system comprising, in combination:
a memory bus;
at least one common memory storage device coupled to the memory bus;
a plurality of nodes coupled to the memory bus wherein each of the plurality of nodes comprises:
a processor which generates a data signal, an address signal, memory control signals, and block address configuration signals;
a local bus coupled to the processor;
a local memory device coupled to the processor;
a configuration bus coupled to the processor; and
an address translator for generating address signals on the memory bus based on stored values.

5. A data processing system in accordance with claim 4 further comprising a digital transceiver coupled to the memory bus for connecting another similar system.

6. A data processing system in accordance with claim 4 wherein the address translator is a dual ported memory device which functions as an address look-up register that converts an address signal from the local bus to another address which is presented to the common memory bus.
